(19) United States
(12) Patent Application Publication
(10) Pub. No.: US 2021/0264886 A1
(43) Pub. Date: Aug. 26, 2021

(54) Musical Instrument Support Retainer

(71) Applicant: Peter Pastreich, Sausalito, CA (US)

(72) Inventor: Peter Pastreich, Sausalito, CA (US)

(21) Appl. No.: 16/799,273

(22) Filed: Feb. 24, 2020

(51) Int. Cl. G10G 5/00

(52) U.S. Cl. CPC G10G 5/00

(57) ABSTRACT

A support retainer includes a first side element, a second side element, a front element, and a rear element, and a top element, wherein the elements are attached together to form a generally quadrilateral configuration with a hollow interior and wherein the top element is adapted to include a hand access opening. The support retainer further includes a receptacle assembly disposed in the hollow interior of the support retainer for depositing items thereon, the receptacle assembly accessed through the hand access opening. The support retainer still further includes a stabilizer assembly fixedly attached to a line of joinder of the front element and the top element, wherein the stabilizer assembly is rounded to receive a musical instrument bout thereupon.

### STATEMENT REGARDING FEDERALLY SPONSORED RESEARCH OR DEVELOPMENT

Not applicable.

### FIELD OF THE INVENTION

The concepts, articles and techniques described herein relate to a musical instrument stand intended for the general reduction of weight and greater ability to stably mount and store a large and heavy, generally fragile, musical instrument, as well as its ancillary items.

### BACKGROUND

The benefits of stably storing fragile musical instruments when they are not in use is well known. For example, string basses, cellos, and violas de gamba are examples of such musical instruments that are not configured to stand in a stable fashion when not being played. During, before, and after rehearsals and concerts, musicians will, upon occasion, leave the instruments onstage when they themselves are not onstage. Without being bound by any particular theory, this practice is likely more common with larger musical instruments as compared with smaller (e.g., violin and violas) musical instruments. The placement of instruments on the stage floor or leaned against chairs is believed to increase the risk of damage to the instruments. Furthermore, particular instruments may require ancillary items such as a rosin block or cleaning cloth which are best kept in proximity to the instruments. Such ancillary items may be misplaced if left on chairs and stools when not in use.

Although certain proposals have been advanced for providing a suitable stand to be used with such large, fragile instruments, such stands typically are cumbersome to utilize, require assembly prior to use, and attempt to achieve an objective of making a smaller and easily transportable stand convenient for travel purposes. One such device is found in U.S. Pat. No. 9,214,141 to McNutt (Stand and Cradle For Double Bass and Cello), in which the stand is formed by the cumbersome task of unlatching supports and determining proper angles with which the stands should be assembled prior to use. This process adds to the tedious nature and risks of damage associated with the transporting of such large instruments. Similarly, another device found in U.S. Pat. No. 10,347,225 to Ng et al. (System and Method a Mobile Cello Stand) leverages ground contact working cooperatively with the stand to provide stabilization and achieve its objective of making a smaller, transportable, instrument stand that also is assembled prior to use.

### SUMMARY

According to one embodiment of the invention, a generally quadrilateral 5 sided, non-marking, base-weighted, portable, stable, bout-oriented, hollow, hand-accessible, support retainer that has a first side element, a second side element opposing the first side element, a front element and a back element opposing the front element, each such member having a bottom edge defining a bottom perimeter, and a top element extending across a portion of the first and second side elements defining an access assembly to the interior walls of the first side, second side, front and back elements. The support retainer includes a stabilizer assembly disposed on the upper cornice of the front element to receive the bout of an instrument. The support retainer also includes a positionable receptacle assembly within the interior walls of the first side, second side, front and back elements of the support retainer. The support retainer also includes a plurality of traction devices disposed on the exterior surface of the bottom perimeter. The support retainer further includes a transport configuration on upper portions of the elements.

According to another embodiment, the support retainer also includes a locking assembly disposed on the front element, reducing the likelihood of the instrument shifting when leaning on the stabilizer assembly.

According to another embodiment, the support retainer also includes a balancing means disposed on the lower exterior surface of the first and second side elements to improve the balance of the support retainer when the instrument is leaned on the stabilizer assembly.

The use of directional terms herein is meant to be relative to the orientation shown in the Figures to give context to the interplay and relative location of various regions or parts of the receptacle. Such terms include “front”, back”, “side”, “top”, “bottom”, etc. These terms are meant to give context to the relative location of indicated parts of the receptacle relative to other parts of the receptacle as shown in the orientation depicted in the figures, and are not meant to be limiting on the scope of the receptacle in any other fashion unless specifically indicated.

### BRIEF DESCRIPTION OF THE DRAWINGS

The concepts, devices and techniques will be understood and appreciated more fully from the following detailed description taken in conjunction with the appended drawings in which:

FIG. 1 is a side perspective view showing the support retainer in accordance with an embodiment of the present disclosure.

FIGS. 2 and 2A are a side view of the support retainer in accordance with an embodiment of the present disclosure.

FIG. 3 is an operational view of the support retainer of an embodiment of the present disclosure.

FIG. 3A is an operational view of the support retainer of an embodiment of the present disclosure.

FIG. 4 is a bottom view of the support retainer of an embodiment of the present disclosure.

### DETAILED DESCRIPTION

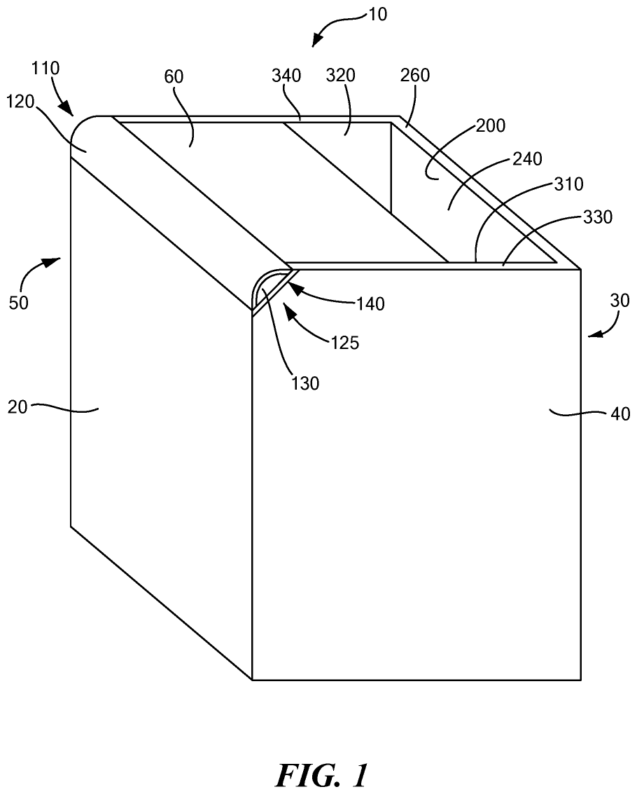

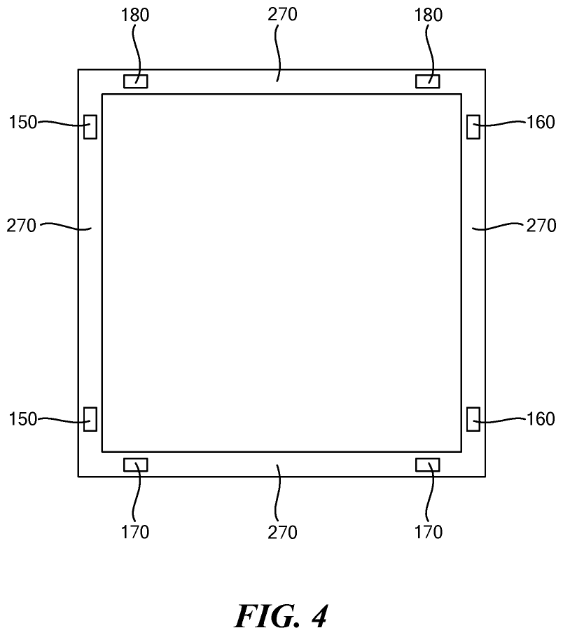

Referring to the drawings, FIGS. 1 through 4, in which like elements are provided having like reference designations throughout the several views, a generally quadrilateral 5 sided, non-marking, portable, stable, bout-oriented, hollow, hand-accessible, support retainer is shown.

The support retainer as used herein is constructed in whole or in part from any suitable material including, but not limited to a wood, plastic, light-weight metal, composite, or other durable lightweight material. In one embodiment, the device comprises a support retainer 10 constructed from a light-weight material, such as wood. The wood comprising the support retainer can be of various densities, including but not limited to balsam fir, spruce and white pine. The support retainer 10 provided has structural characteristics such that the support retainer has the capability of being light weight, (e.g., less than about 2-15 kg) thereby enabling a user to easily transport the support retainer as desired.

As shown in FIGS. 1 through 4, a retainer according to an example embodiment includes a support retainer 10 comprised of a first side element 40, a second side element 50, a front element 20 and a back element 30, each such members having a bottom edge defining a bottom perimeter 270, and a top element 60. In an alternative embodiment, the first side element 40 and second side element 50 may be tapered. In an alternative embodiment, the support retainer 10 may include a bottom element, not shown.

Collectively, the retainer formed by the first side element 40, second side element 50, front element 20, back element 30, and top element 60, whether or not a bottom element is included, shall be referred to as a generally quadrilateral construction. In another embodiment, the generally quadrilateral construction may comprise elements that are generally cubical or rectangular shaped. The generally quadrilateral construction may be assembled in various ways, including by using screws, bolts, clamps, adhesives or in a similar manner.

As shown in FIGS. 1 through 3, the support retainer of the present invention includes a stabilizer assembly 110 located generally along a line of joinder of the top of said front element 20 and said top element 60, preferably by an angularly inwardly projecting cornice 125. More particularly, at the junction where the front element 20 is fixedly attached to the top element 60 a cornice 125 is cut at approximately a 45-degree angle to the top and front edges. A soft resilient material, such as leather, vinyl or similar material 120 covers cushion 130 of polyester or other similar material, attached to a cornice base 140 that runs the width of the front element 20, attaching to the top element 60 and each of the first side element 40 and second side element 50. The soft resiliency of the material enables the material to be covered over cushion 130 and avoids damage to the surface of the instrument. The cushion 130 is configured to receive a C-bout of a musical instrument thereupon to avoid damage to the instrument. The term non-marking as used herein shall be understood to refer to the flexible material 120 covering the cushion 130 of cornice 125 which will largely prevent scratching of the musical instrument upon receipt by cushion 130.

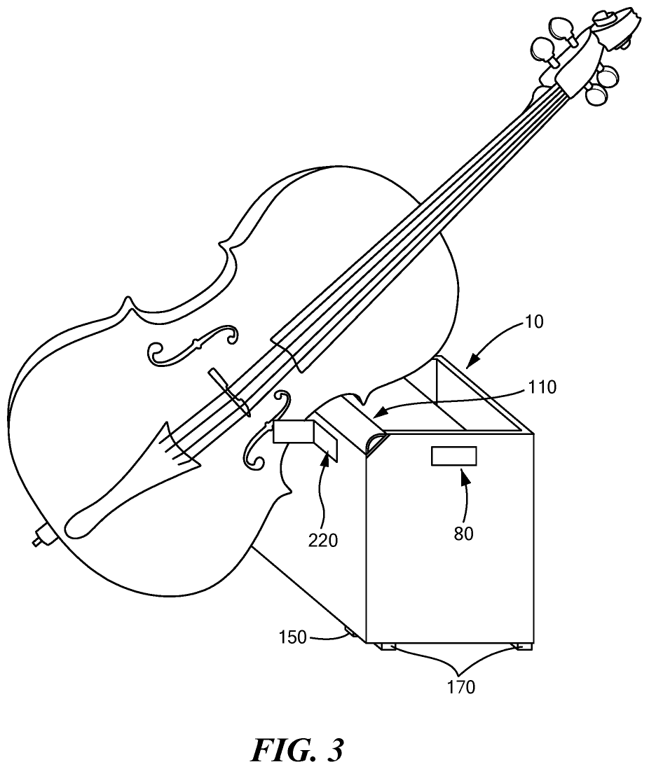

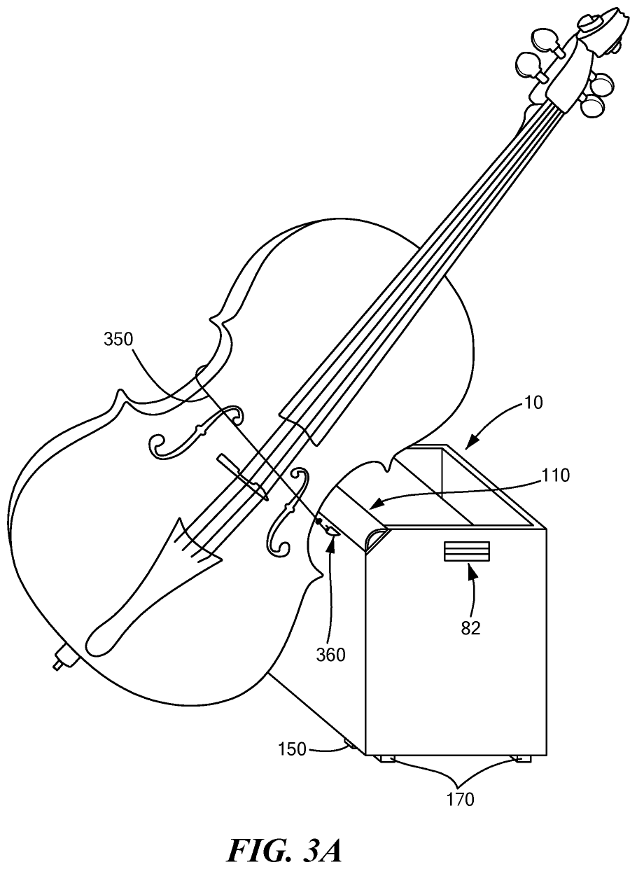

The narrow waist of a large stringed instrument is typically termed a “Center bout”, C-bout” or “C Rib”. In the present disclosure, an instrument having a C-bout is leaned against the support retainer such that the C-bout portion of the instrument is supported by the stabilizing means 110, as shown in FIG. 3. The term “bout oriented” shall be understood herein to mean a supporting means configured to receive an instrument that is oriented such that its C-bout is resting upon the stabilizer assembly 110 which is configured to receive the C-bout portion of the musical instrument. By the stabilizer assembly 110 receiving the C-bout of an instrument, the stability of the instrument is improved and movement or slippage of the instrument is reduced. This increased stability is accomplished by engaging the top of the C-bout with the stabilizer assembly 110 which is disposed at a height that enables the instrument to be leaned in a manner such that the C-bout engages with the stabilizer assembly 110 while the instrument remains on the floor, as shown in FIG. 3.

In an alternative embodiment, the stabilizer assembly 110 is disposed at a height that enables the instrument to be leaned in a manner such that the middle of the C-bout engages with the stabilizer assembly 110, as shown in FIG. 3A.

The term hollow as used herein shall be understood to refer to the void formed when the first side element 40, second side element 50, front element 20 and back element 30 are configured together and adapted to create a box leaving a generally empty void between all of the elements 40, 50, 20, 30. By way of example, based upon the external dimension of the support retainer 10, not including the dimension of any handles, traction devices, locking assembly, or the fact that a hand access opening created by the top element 60 is a non-surface, being approximately 50 cm high, approximately 40 cm deep and approximately 40 cm wide, it would have an exterior volume of approximately 80,000 cubic centimeters. Taking into account a thickness of the support retainer 10 being approximately 2.5 cm, the interior volume of the support retainer would be 66,797 cubic centimeters (13,203 cm subtracted for the volume of the thickness of the support retainer). Accordingly, the void, or hollow cubic area, comprises approximately 83% of the volume of the exterior of the support retainer. In a representative embodiment of the invention, the dimensions of the support retainer 10 would be from approximately 20-90 centimeters high, approximately 20-60 centimeters deep and approximately 10-60 centimeters wide, and the thickness of the support retainer would be from approximately 0.5-30 centimeters, thereby creating a void, or hollow area, which would be approximately 5-95% of the dimension of the support retainer as a whole. Other dimensions are of course possible, so long as the selected dimensions result in improving the stability of the support retainer 10.

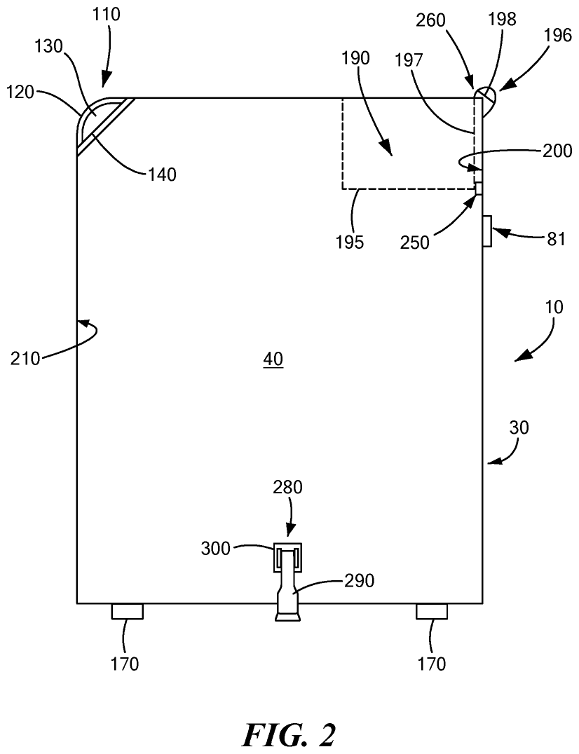

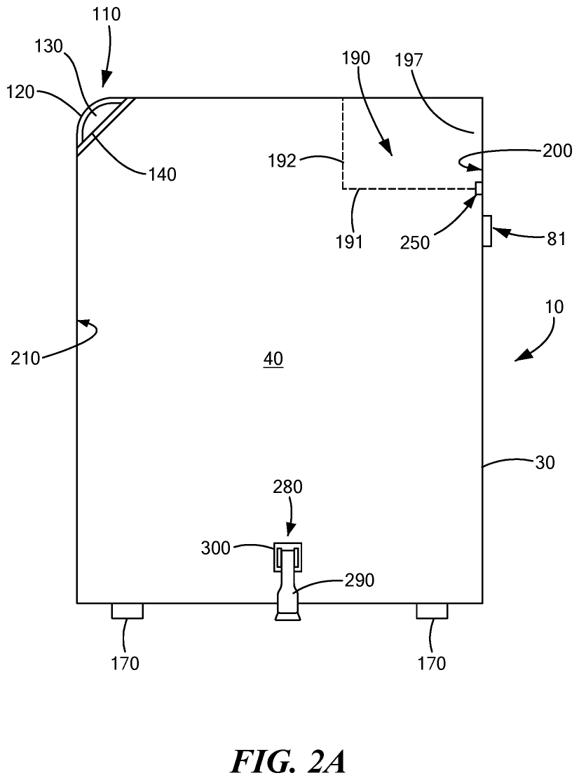

The present invention comprises a positionable receptacle assembly 190, as shown in FIGS. 2 and 2A, in the hollow interior of the support retainer for the deposit and storage of ancillary instrument- and musician-related items, adapted to retain a liner which conforms generally to the configuration of the receptacle assembly 190.

In an example embodiment, the receptacle assembly 190 comprises a basket device 195 (shown in dotted lines in FIG. 2) removably disposed over the top edge 260 of the rear element 30 such that the basket device 195 is supported by the rear element 30. In this embodiment, the basket device may be easily removed to access the ancillary instrument- and musician-related items deposited and stored therein, as well as easily cleaned. In this embodiment, the basket device 195 is disposed with a U-shaped bracket or hook portion 196 that fits over the top edge 260 of the rear element 30. Extending between the U-shaped bracket and the basket device is an arm 197. Arm 197 determines a vertical position of the basket device 195 on the rear element 30. A longer arm 197 makes the basket device 195 sit lower on the rear element 30. A shorter arm 197 makes the basket device 195 sit higher on the rear element 30. Hook portion 196 may include a flexible tab or biasing tab 198 that protrudes towards rear element 30 and secures hook portion 196 to the rear element 30 regardless of the thickness of the rear element 30. Using flexible tab 198, hook portion 196 can mate with varying thicknesses of rear element 30. In another embodiment, the basket device 195 is disposed with a U-shaped bracket or hook portion 196 that fits over the top edge 330 of first side element 40 (not shown). In yet another embodiment, the basket device 195 is disposed with a U-shaped bracket or hook portion 196 that fits over the top edge 340 of second side element 50 (not shown). In yet a further embodiment, the basket device 195 is disposed with a U-shaped bracket or hook 196 that fits over the top edge 260 of the rear element 30 and one or both of the top edges 330 and 340 of the first side element 40 and second side element 50, respectively (not shown). The basket device 195 may be configured in any size smaller than that of the hand access opening 240 such that the basket device 195 can be removed from the support retainer 10 through the hand access opening 240. The basket device 195 may be made from a durable plastic, metal, or rubber material having a non-marking rubber or rubber-like material coating that will not scratch the instrument.

In another example embodiment, as shown in FIG. 2A, the receptacle assembly 190 comprises a positionable shelf or platform 191 (shown in dotted lines in FIG. 2A) disposed on the interior wall 200 of rear element 30. The shelf or platform 191 is positionable to be adjusted to a plurality of heights within the interior of the support retainer by adjusting the location of positioning members 250 which are adjustably disposed within the interior wall 200 of rear element 30. The positioning members 250 are also easily accessible through the bottom of the support retainer. In an example embodiment, the shelf or platform may be disposed on the interior wall 210 of front element 20, or the interior wall 310 of first side element 40 or interior wall 320 of second side element 50, to prevent items disposed on the shelf or platform 191 from falling off of the shelf or platform 191. In another embodiment, the shelf or platform 191 may include wall members 192 (shown in dotted lines in FIG. 2A) on one or more of the perimeters of the shelf to prevent items disposed on the shelf or platform 191 from falling off of the shelf or platform 191.

In an example embodiment, the receptacle assembly 190 extends to the inner edge 210 of the front element 20. In another embodiment, the receptacle assembly 190 extends toward the inner edge 210 of the front element 20 but does not reach the inner edge 210. In such an embodiment, the receptacle assembly can be of various widths as, for example, between about 5 cm and about 30 cm. The receptacle assembly 190 may be fixedly attached to the inner wall 310 of the first side element 40 and inner wall 320 of the second side element 50. In a further example embodiment, receptacle assembly 190 is fixedly attached to only the inner wall 310 of the first side element 40. In another example embodiment, receptacle assembly 190 is fixedly attached to only the inner wall 320 of the second side element 50. In yet another example embodiment, receptacle assembly 190 is attached only to the inner wall 200 of rear element 30. In yet another example embodiment, receptacle 190 is attached only to the inner wall 210 of front element 20. The receptacle assembly 190 serves as a surface upon which a user may store ancillary instrument items or other personal items thereon, including but not limited to rosin, rags, pencils, cell phone, etc. The receptacle assembly 190 may be configured to include a fabric covering to protect such instrument accessories or other personal items.

The term hand-accessible as used herein shall be understood to refer to the top element 60 of the support retainer adapted to include a hand access opening 240 to reach into said receptacle assembly 190 in the interior of the support retainer for depositing or receiving the ancillary items therein, as shown in FIG. 1. As preferably embodied, the hand-access opening 240 is located generally along a line of joinder of the top element 60 and the rear element 30 and generally coinciding with a top edge 260 of the rear wall 30 of the support retainer opposite the stabilizing means 110.

The support retainer also includes a plurality of traction devices disposed on the exterior bottom edge of the bottom perimeter 270, as shown in FIGS. 2-4. In an example embodiment, the bottom edge of each of the elements 20, 30, 40, 50 have traction devices 150, 160, 170 and 180, respectively, which creates traction between the bottom of the support retainer and a floor or ground. The term non-skid as used herein shall be understood to mean that the shifting of the support retainer will be minimized when an instrument is placed upon the stabilizing means 110 as a result of the traction devices 150, 160, 170 and 180. Further, the traction devices 150, 160, 170 and 180 are comprised of a rubber or rubber-like material having a coefficient of friction designed to allow for improved traction for the support retainer. Alternatively, the traction devices 150, 160, 170, and 180 may be of any other suitable configuration known in the traction art to provide stability.

The term base-weighted as used herein shall be understood to mean that the bottom perimeter 270 of the first side element 40, second side element 50, front element 20 and back element 30 is weighted to provide a lower center of gravity to improve the stability of the support retainer.

In an alternative embodiment the support retainer includes a locking assembly mounted to the front element 20, beneath the stabilizer assembly 110, such as a pair of retractable hooks 220, as shown in part in FIG. 3, adjustably extending out from the front element 20, to enable instruments of varying thicknesses to be secured. The locking assembly may be made from a durable plastic or non-marking rubber or rubber-like material that will not scratch the instrument. The locking assembly 220 are designed for an instrument to rest against the stabilizer assembly 110 in between the locking assembly 220. Preferably, the instrument is secured between the locking assembly so that no additional hardware is needed. The locking assembly can be mounted to the front element of the support retainer in many ways, including by using screws, bolts, or clamps and can be permanently or removably mounted. When not in use, or when stored, or when desired, the locking assembly 220 may be retracted and remain in the same plane adjacent the front element 20. By disposing an instrument between locking assembly 220 the instrument remains in a generally fixed location on the support retainer, thereby minimizing damage to or shifting of the instrument.

In another example embodiment, as shown in FIG. 3A, the locking assembly comprises a resilient member 350, such as a strap or shock cord, used to secure the instrument to the support retainer 10. The resilient member 350 may include a buckle or ratcheting mechanism, or other closure mechanism, and may be attached or detached from the support retainer 10. In an example embodiment, the resilient member 350 is disposed on the support retainer 10 by mounting means, such as d-rings, or hook and loops (Velcro), or any other means for attaching the resilient member to the support retainer 10 (not shown). One end 360 of the resilient member 350 may be attached to the support retainer 10; the other end 370 (not shown) may either be attached to the support retainer 10, free to traverse the support retainer 10, or limited in mobility relative to the support retainer 10; wherein, in use, the one end 370 of the resilient member 350 is detached from the support retainer 10 and secured around an instrument engaged with the stabilizer assembly 110, and then re-attached to the support retainer 10, in order to maintain the instrument in place. Although not shown in the drawings, the resilient member 350 may alternately or additionally include an adjustment device to permit the resilient member to be adjustable. The overall length of the resilient member 350 when coupled with buckle segments (not shown) can be adjusted to provide a snug and secure arrangement for retaining the instrument to the support retainer 10. It should be apparent that other types of adjustment devices or securing mechanisms may be used together with, or in place of straps, adjustment device and/or buckle segments. Such examples may include harnesses, releasable clamps, elastic cords or other elastic components, and any other mechanism that can contribute to securing the instrument to the support retainer 10. The resilient member 350 is manufactured from a flexible material having a material coating that will not scratch the instrument.

In an example embodiment as shown in FIG. 3, transport configuration 80 is connected to the first side element 40 and another transport configuration 80 (not shown) is connected to the second side element 50, to allow for easy transportability of the support retainer by the user. According to some embodiments, transport configuration 80 are integrally molded holes to receive a user's hand. In another embodiment, transport configuration may be provided as an integrally molded feature on the rear support body 30, shown as 81 in FIG. 2 to allow for transport by the user. In another embodiment, as shown in FIG. 3A, the transport configuration comprises gripping grooves 82 provided on an outside surface of the first side element 40, and another transport configuration 82 (not shown) provided on an outside surface of the second side element 50, in order to facilitate the grasping of the support retainer. The gripping grooves are realized as elevations on the outside surface of the first and second side element 40, 50. In yet another embodiment, the hand-access opening 240 serves as the transport configuration of the support retainer, wherein a user's hand may grip the edge of top element opposite the stabilizing assembly 110.

According to another embodiment, the support retainer also includes an immobilizer means 280 disposed on the lower exterior surface of the first and second side elements to maintain the position of the support retainer when the instrument is resting on the stabilizer assembly 110. The immobilizer means may comprise a door stopper portion 290 that can be pivotally coupled to a plate 300 as shown in FIG. 2. By lowering the door stopper portion 290 into a closed position on both the first side element 40 and second side elements 50 (not shown), the door stopper portion 290 engages with a floor or ground, thereby impeding the movement, and in particular, the sliding of the support retainer. By raising the door stopper portion 290 into an open position on both the first and second side elements 40, 50, the supporting means may be easily readjusted and moved on the floor or ground.

While the disclosed concepts, devices and techniques have been described and illustrated in conjunction with a number of specific embodiments, those skilled in the art will appreciate that variations and modifications may be made without departing from the principles of the concepts sought to be protected herein as herein illustrated, described and claimed. The concepts may be embodied in other specific forms without departing from its spirit or essential characteristics of the concepts sought to be protected. The described embodiments are to be considered in all respects as only illustrative, and not restrictive. The scope of the subject matter sought to be protected is, therefore, indicated by the appended claims, rather than by the foregoing description. All changes which come within the meaning and range of equivalency of the claims are to be embraced within their scope.

Having thus described the concepts, what is claimed is:

1. A bout-oriented, hand-accessible, hollow, generally quadrilateral five-sided, support retainer comprising:
A first side element, a second side element, a front element, and a rear element, and a top element, wherein said elements are attached together to form a generally quadrilateral configuration with a hollow interior, and wherein said top element is adapted to include a hand access opening;
a receptacle assembly disposed in the hollow interior of the support retainer for depositing items thereon, said receptacle assembly accessed through the hand access opening; and
a stabilizer assembly fixedly attached to a line of joinder of said front element and said top element, wherein said stabilizer assembly is configured to receive a musical instrument bout thereupon.

2. The support retainer according to claim 1, wherein said receptacle assembly is comprised of a basket device.

3. The support retainer according to claim 1, wherein said stabilizer assembly is rounded and cushioned.

4. A non-marking, portable, stable, bout-oriented, hand-accessible, hollow, generally quadrilateral five-sided, support retainer comprising:
A first side element, a second side element, a front element, and a rear element, each element having a bottom edge defining a bottom perimeter, and a top element, wherein said elements are attached together to form a generally quadrilateral configuration with a hollow interior, and wherein said top element is adapted to include a hand access opening;
a receptacle assembly disposed in the hollow interior of the support retainer for depositing items thereon, said receptacle assembly accessed through the hand access opening;
a stabilizer assembly fixedly attached to a line of joinder of said front element and said top element, wherein said stabilizer assembly is configured to receive a musical instrument bout thereupon; and
one or more traction devices disposed on the exterior portion of the bottom perimeter of the support retainer.

5. The support retainer according to claim 4, wherein said receptacle assembly is comprised of a basket device.

6. The support retainer according to claim 4, wherein said receptacle assembly is comprised of a shelf.

7. The support retainer according to claim 4, wherein said stabilizer assembly is rounded and cushioned.

8. The support retainer according to claim 4 further comprising a transport configuration disposed on an element for transporting said support retainer by a user.

9. The support retainer according to claim 8 wherein said transport configuration is disposed on one or both of said first side element or said second side element for transporting said support retainer by a user.

10. The support retainer according to claim 8 wherein said transport configuration is disposed on said rear element.

11. The support retainer according to claim 4 further comprising locking assembly mounted thereon to enable a musical instrument bout to be disposed between said locking assembly in a generally fixed location.

12. The support retainer according to claim 11 wherein said locking assembly is comprised of a pair of members disposed on and extending out from said front element.

13. The support retainer according to claim 11 wherein said locking assembly is comprised of a strap.

14. The support retainer according to claim 4 further comprising an immobilizer means disposed on the lower exterior surface of one or more of said elements to maintain a position of said support retainer when a musical instrument bout is resting thereupon.

15. The support retainer according to claim 14, wherein said immobilizer means is disposed on the lower exterior surface of said first side element and said second side element.

16. The support retainer according to claim 4, wherein said bottom perimeter is base-weighted.

17. A non-marking, portable, stable, bout-oriented, hand-accessible, hollow, generally quadrilateral five-sided, support retainer comprising:
A first side element, a second side element, a front element, and a rear element, each element having a bottom edge defining a bottom perimeter, and a top element, wherein said elements are attached together to form a generally quadrilateral configuration with a hollow interior, and wherein said top element is adapted to include a hand access opening;
a receptacle assembly disposed in the hollow interior of the support retainer for depositing items thereon, said receptacle assembly accessed through the hand access opening;
a stabilizer assembly fixedly attached to a line of joinder of said front element and said top element, wherein said stabilizer assembly is rounded and cushioned to receive a musical instrument bout thereupon;
one or more traction devices disposed on the exterior portion of the bottom perimeter of the support retainer;
a transport configuration disposed on one or both of said first side element or said second side element for transporting said support retainer by a user;
a locking assembly mounted thereon to enable a musical instrument bout to be disposed between said locking assembly in a generally fixed location; and
an immobilizer means disposed on the lower exterior surface of said bottom perimeter to maintain a position of said support retainer when a musical instrument bout is resting thereupon.

18. The support retainer according to claim 17, wherein said receptacle assembly is comprised of a basket device.
